(19) United States
(12) Patent Application Publication
(10) Pub. No.: US 2014/0365495 A1
(43) Pub. Date: Dec. 11, 2014

(54) Systems and Methods for Storing and Identifying Connections Between People, Places, and Things

(71) Applicant: Jeremy M. Legarda, Brooklyn, NY (US)

(72) Inventor: Jeremy M. Legarda, Brooklyn, NY (US)

(21) Appl. No.: 14/302,409

(22) Filed: Jun. 11, 2014

Related U.S. Application Data
(60) Provisional application No. 61/833,918, filed on Jun. 11, 2013.

(51) Int. Cl. G06F 17/30; H04L 12/58

(52) U.S. Cl. CPC G06F 17/30598; H04L 51/046
USPC 707/740

(57) ABSTRACT

The present subject discloses computer implemented systems and methods including: a processing engine embodied in a processor that is in operable communication with a user interface, wherein the processor receives data elements including a plurality of categories and a plurality of connectors, wherein each category represents a person, a place, or a thing, and each connector represents a connection between two categories, wherein the processing engine acts on the categories and connectors received to determine a closed-loop series of categories and connectors and, in response to the determination of a closed-loop series of categories and connectors, the processing engine automatically generates a notification of the closed-loop through the user interface.

### CROSS-REFERENCE TO RELATED APPLICATIONS

This application incorporates by reference and claims priority to U.S. Provisional Application No. 61/833,918 filed on Jun. 11, 2013.

### BACKGROUND OF THE INVENTION

The present subject matter relates generally to systems and methods of recognizing connections (i.e. relationships) between people, places, and things. More specifically, the present subject matter provides systems and methods that automatically detect and alert a user of connections between people, places, and things, particularly those connections that lead to actionable opportunities.

We live in an information age. We constantly collect information and data about the people, places, and things with which we interact. Whether in the data stored through our smartphones, in the detailed notes within a customer relationship management application, or lost in the back of our minds, we gather, store, and often carry around significant detail about the people, places, and things with which we interact. There are connections hidden in that data that are difficult for people to detect and connect, both due to degrees of separation as well as the sheer quantity of data available. Unfortunately, the undiscovered connections represent missed opportunities to develop relationships and engage more meaningfully with our surroundings.

People would like to spontaneously (or not) get the perfect gift for their friends and family. People would like to be able to detect and make valuable connections between people they know. People would like to capture otherwise missed opportunities to interact with those around them.

Current technology commonly in use does not facilitate the automatic detection of these connections in any comprehensive manner. There are numerous applications that enable users to view single degree information (i.e., people's interests, hobbies, birthdays, location, connections with friends, etc.). You may, for example, store a friend's birthday in your calendar and have it sync with that person's contact information in your phone. As a result, you can pull up the person's contact information and view their birthday, as well as that person's name, phone number, address, and any notes you may have included in the data record. In some instances, the connections can be viewed in multiple degrees of separation (e.g., second and third degree connections on social media platforms). But even if the data and connections are identified and stored in current systems, those systems fail to proactively alert users to their existence. Instead, the data is stagnant, available only through intentional and directed user searches. A user must intend to find specific connections in order to actually find them.

Accordingly, there is a need for systems and methods that provide users with alerts regarding automatically detected connections between people, places, and things that lead to actionable opportunities, as described and claimed herein.

### BRIEF SUMMARY OF THE INVENTION

The present disclosure provides systems and methods for recognizing connections (i.e. relationships) between people, places, and things. In some sense, the whole world can be thought of as being two things: (1) categories; and (2) connectors associated with the categories. When the connectors associated with the categories inter-relate, connections may be made between the categories.

As used in this disclosure, the categories people, places, and things are intended to be broadly descriptive of all entities, locations, items, events, etc. It is understood that these categories are stylistic in choice and the solutions provided herein may make use of any number of such categories, including a single category. Throughout this disclosure, it is intended for the category “people” to be natural people with whom the user has information, “places” to be geographic locations, and “things” to be the broad catch-all category within which everything else falls, including objects, sports teams, bands, events, groups, organizations, etc.

Connectors may be associated with each person, place, and thing. Connectors may be classified as various types, for example, as any one of the following: (i) sentiment; (ii) market; (iii) profession; (iv) location; and (v) relation. “Sentiment” may include, for example, likes, dislikes, loves, hates, allergic to, etc. “Market” may include, for example, buys, sells, owns, uses, has, needs, wants, makes, wears, etc. “Profession” may include, for example, expert at, teaches, works with, etc. “Location” may include, for example, been to, lives in, is from, attended, is part of, takes place in, etc. “Relation” may include, for example, knows, friends with, close friends, acquaintances, married to, siblings with, in-laws, grandparents, etc. These various connections are merely presented for illustrative purposes. It is understood that those skilled in the art will recognize numerous variations or additions to this list based on the descriptions provided herein.

The systems and method provided herein collect, store, and categorize data entered by a user or pushed/pulled from related systems. The systems and methods further provide an algorithmic search engine that actively searches for connections between connectors related to category data in any of a multitude of degrees of separation. When a connection is detected between two or more people, places, or things, the system and method notify the user a connection has been found. In further examples, the notification to the user includes an actionable item through which a user may provide a command to act on the notified connection.

The automatic alert feature solves the problem that users are incapable of remembering everything about everyone they meet while simultaneously evaluating the full scope of known data to identify potential connections. Examples in which the alert includes an actionable item further solve the problem of how difficult it may typically be to act on potential connections, even once they are identified.

The data related to the people, places, and things can be entered manually into the system by the user or may be pushed or pulled into the system through other applications, such as contact list databases, websites (i.e., Wikipedia, social media profiles, etc.), private and public calendars, maps, etc. For example, the system may integrate with one or more social media platforms such that relevant people, places, and things are pulled into the system.

Connection information may be manually entered, pulled into the system from third party databases or systems, or may be actively and directly transmitted to a user's device by a third party. In one example, connection information is pulled into the system through related social media accounts. For example, for a given person, numerous connection data may be drawn from the related social media account (e.g., the person's likes, profession, location, background, etc.). Connection information may be static or dynamically updated, whether in real-time or otherwise. For example, a local club may be a “thing” and its connections may include the DJ performing at the club that night. By synching with the club's calendar, the system may update the club's connections on a daily basis.

The purpose of the systems and methods are to efficiently connect any person, place, or thing, to any other person place or thing, triggered by the identification of applicable connections. The systems and methods may employ one or more proactive algorithms looking for specific types of connections. Conceptually, the algorithm is looking for synergistic matching of connector data to “close the loop” on a series of two or more related connector data points from which an alert or actionable item may be created. The trigger for the search may be anytime a data field is updated within the system. For example, by adding a new connector within the data records of an existing person, the system may search for and find a synergistic connection to which it will alert the user.

In one example, the systems and methods are embodied in a mobile application. A user has a date with a woman named Megan. On that date, Megan tells the user that she loves wooden bracelets. The user enters this information as a “sentiment” connector (i.e., Megan loves wooden bracelets) and also adds “wooden bracelets” as a category (i.e., thing) in the mobile application, but then forgets about it and never speaks with Megan about it again. One year later, the user meets Vlad, a designer looking for work in the U.S. The user enters into the mobile application that Vlad wears a smartwatch, is staying locally with a friend, and makes wooden bracelets. In response to the user entering into the mobile application that Vlad makes wooden bracelets, the mobile application makes the connection and notifies the user that Vlad makes wooden bracelets and Megan loves wooden bracelets. This notification enables the user to act on the identified connection and purchase from Vlad a wooden bracelet that Megan will love. In some embodiments of the system and method, for example if the user were to enter information like Vlad's online retail store, the notification from the mobile application may include a link to the online store to make the purchase of a wooden bracelet even easier (specifically more easily actionable) for the user.

The value of the systems and methods may be even more apparent when making connections across multiple degrees of separation. For example, a user may meet a group of five people at Bob's party. The user may enter that each of these five people went to high school with Bob, but may not have the information to specifically note which high school that was. Then, months later, the user enters the high school that Bob attended and, without changing the entries for Bob's five friends, the system and method may be able to identify that all six of those entries (Bob and his five friends) attended the newly identified high school and make connections using that information. This demonstrates the exponential increase in value of the systems and methods based on the addition of categories and connectors.

The following examples further illustrate uses for the systems and methods provided herein. Each example illustrates various advantages of the presently disclosed systems and methods. While some of the advantages described in the examples below can be achieved using existing systems, the unique approaches described herein bring further depth to the meaningful connections that can be achieved between people, places, and things.

In a first example, the user is going to Atlantic City and will see the musical artist Tiesto play at the Borgata on Thursday Night and wants to play roulette at the casinos. The user has an extra ticket and would rather take a date than a friend. The user would like to take the girl he met at Avenue (a club), Adriana, whom he recalls dancing with to Tiesto's music. First, the user logs into the mobile application and types in Tiesto. This pulls up all of the category entries (i.e., people) in the database that are related to Tiesto, whether people, places, or things. The user then expands the group “loved by” to see which category entries (i.e., people) love Tiesto. The user then verifies that Adriana loves Tiesto. By selecting Adriana, the user then learns that he did meet her at Avenue, her birthday is next week (the week of the concert), she loves the number 21, she loves to drink white Russians, and she loves the movie The Big Lebowski. The user then selects the location Borgata and sees all of the people, places, and things connected to the Borgata, grouped by connector type. The user expands the group “works at” to find out that his college friend Eugene promotes at the club mur.mur in the Borgata.

After this research, the user calls Adriana for a surprise two-day getaway. While there they play Roulette, the user tells the cocktail waitress to “keep the white Russians coming,” the user plays 21 because it is her favorite number, the user calls Eugene to get a table at the club, and dances with Adriana to Tiesto, only this time live rather than on a recording.

In a second example, a user talks to his neighbor, Jake, and finds out that Jake got new job as a producer at the Food Network, that Jake has helped his friends make a Kickstarter video, and that Jake's friends own Yonkers Brewery and are looking for a distributor. The user first logs into his mobile application, finds Jake as a person, notes that the app already includes Jake's address (location), that he lives in SoHo (location), and that he is a producer (profession). The user then adds that Jake works at Food Network (profession), simultaneously adding Food Network as a thing, adds that Jake makes Kickstarter videos (Kickstarter is already registered as a thing in the user's app), adds John and Nick as people and friends with Jake (relation) and owner's of Yonkers Brewery (profession), adds Yonkers Brewery as a thing and adds that Yonkers brewery is looking for a distributor (profession). This one conversation with Jake has enabled the user to create a number of new entries for people and things, as well as add connector information to the new and existing entries, which trigger the search for any existing connections. The updated category and connector data is then available in the system to make connections in the future.

In a third example, a user receives an automated message (auto-notification) from the system that Bon Iver is playing a show in town and Bon Iver is a band Lindsay likes. The auto-notification also includes the information that Oscar runs lighting for Bon Iver shows and can get the user backstage access. The auto-notification also includes links through which the user may call Lindsay and Oscar and a link through which the user may purchase tickets to the Bon Iver show.

In this example, here is how the information was populated into the system so the connections could be made to create the auto-notification. The user met Oscar at a bar. Oscar told the user that he does all the lighting for Bon Iver shows and if the user ever wants to go to a free show backstage, to just call him. The user added Oscar as a person (category entry), including various profile attributes such as his Twitter handle, cell number, and email address. Then the user connected Oscar to Bon Iver through the profession connector as “works with.” In the notes section, the user added notes that indicated Oscar does all the lighting for Bon Iver shows and has offered to get the user backstage.

After Oscar was in the system, the user synced the system to a social media site. As part of the social media syncing, the user was asked whether it should collect the social media “likes” from Lindsay, one of the user's social media friends (more specifically, the user was asked to choose from which friends the system should pull the social media likes). Once Lindsay's social media likes were pulled into the system, the system made a connection between Lindsay and Oscar as both being connected to Bon Iver and notified the user of this connection. However, at that time, there were no Bon Iver shows scheduled in the area, so there was no action to take at that time. The system was further synced to a local events calendar. When an event including Bon Iver was added to the local events calendar, the system knew to pull in the information because Bon Iver is a registered category (thing) in the system. Once the calendar information was brought into the system, it made the three-degree connection between Lindsay, Oscar, and the Event all being connected to Bon Iver. The links to call Oscar and Lindsay were derived from their contact information and the link to purchase the tickets was derived from the e-commerce portion of the events calendar to which the system was linked.

In a fourth example, a user is connected with Amy who owns Peter Lugers Steakhouse. Through conversation in April, the user learns Amy is looking for a new manager for the restaurant. The user is also connected with Cristian, who is a restaurant manager and let the user know back in January that he is looking for a new job. Once the user connects Amy (person) to restaurant manager (thing) by the “needs a” connector, the system automatically makes the connection that Cristian is a potential candidate for the job and provides the user with an auto-notification of the connection and a link to send an email to both Amy and Cristian introducing them for further discussion.

These are simple examples of how the systems and methods described herein may work. However, there are numerous examples of the systems and methods described herein may be utilized to accomplish the advantages described.

It is further contemplated that the multitudes of data contained within a developed system described herein may be very valuable. As a result, in some embodiments, access to the system is password protected and, even when synched and in communication with third-party systems, the system described herein does not share information with third parties. That said, in some contemplated embodiments, the systems and methods described herein allow a user to present a token or open a communication through which the user can send (push) to another user selected connection data or allow another user to pull the selected connection data from the user's account. In such embodiments, the user would control the extent to which connection information is shared.

The systems and methods described herein will also be able to accomplish the functions of the systems and methods that came before it. For example, in a specific, but non-limiting example, a user may search for a specific person, place, or thing entered into the system. The system and methods described herein may then identify any connections (i.e., interrelated connectors) related to the searched person, place, or thing and another one or more people, places, and things. The system may provide the user with easy to use, visual, resources that empower the user with resources to see and act on the identified connections. For example, selecting a given person, place, or thing, may result in the display of a mind map or similar visual mapping of the person's, place's, or thing's connections. Although it is contemplated that the connections data may be provided to the user in any format, including lists, charts, etc.

In one example, a computer implemented system includes: a processing engine embodied in a processor that is in operable communication with a user interface, wherein the processor receives data elements including a plurality of categories and a plurality of connectors, wherein each category represents a person, a place, or a thing, and each connector represents a connection between two categories, wherein the processing engine acts on the categories and connectors received to determine a closed-loop series of categories and connectors and, in response to the determination of a closed-loop series of categories and connectors, the processing engine automatically generates a notification of the closed-loop through the user interface. The notification may be an email, an SMS message, a pop up notification from a mobile application, or any other similar notification. The notification may include an actionable item, such as an option to purchase goods or services, an option to communicate the notification to third parties, an option to publish the notification through social media, etc.

In another example, a computer implemented method includes the steps of: updating data elements in memory associated with a processor embodying a matching engine, wherein the data elements include a plurality of categories and a plurality of connectors, wherein each category represents a person, a place, or a thing, and each connector represents a connection between two categories; triggering the matching engine to act on the categories and connectors to determine a closed-loop series of categories and connectors to identify a match; and notifying a user of the match with a notification. The notification may be an email, an SMS message, a pop up notification from a mobile application, or any other similar notification. The notification may include an actionable item, such as an option to purchase goods or services, an option to communicate the notification to third parties, an option to publish the notification through social media, etc.

An advantage of the present systems and methods is that they help users to identify connection between people, places, and things, that the users may not have discovered themselves.

A further advantage of the systems and methods is that they can be used to create actionable items to act on the identified connections.

Another advantage of the systems and methods is that they provide a valuable data-rich resource whose value grows with each added data point.

Another advantage of the systems and methods is that they can be integrated with third-party systems and devices to push and pull information that improves their value.

Still another advantage of the systems and methods is that they equally value all people, places, and things, and the connectors between them, such that even a small detail can be the detail that closes the loop on a series of connectors linking a series of people, places, and things. The minor details become as meaningful as we intrinsically know they are.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic representation of a system within which the methods described herein are embodied.

FIG. 2 is a flow chart depicting the steps taken to create and update data used within the system and methods described herein.

FIG. 3 is a screenshot depicting one example of a user interface through which a user accesses category information for people, places, and things.

FIG. 4 is a screenshot depicting one example of a user interface through which a user accesses connector information for a specific person, place, or thing.

FIG. 5 is a screenshot depicting one example of a user interface through which a user accesses category and connector information for people that work at a location.

FIG. 6 is a screenshot depicting one example of a user interface through which the systems and methods provide an auto-notification of a connection including an actionable item.

FIG. 7 is a screenshot depicting one example of a user interface through which a user may choose to share connector information with another user.

FIG. 8 is a flow chart depicting a method through which the system identifies a matching connection and notifies a user of the matching connection.

FIG. 9a is a schematic representation of a group of connectors prior to a match being made between them.

FIG. 9b is a schematic representation of a group of connectors after a match is made between them.

FIG. 10a is a schematic representation of a group of connectors prior to a match being made between them.

FIG. 10b is a schematic representation of a group of connectors after a match is made between them.

### DETAILED DESCRIPTION OF THE INVENTION

The systems and methods 10 disclosed herein are described by way of the following examples. In these examples, the various features and functions of the systems and methods 10 are described with reference to a user 12, a computing device 14 (e.g., smartphone, tablet computer, wearable computing device, laptop computer, etc.), a processing engine 16, and memory 18. These systems and methods may further be embodied in a communications network 20, through which the computing device 14 may interact with other systems 22 and other devices 24.

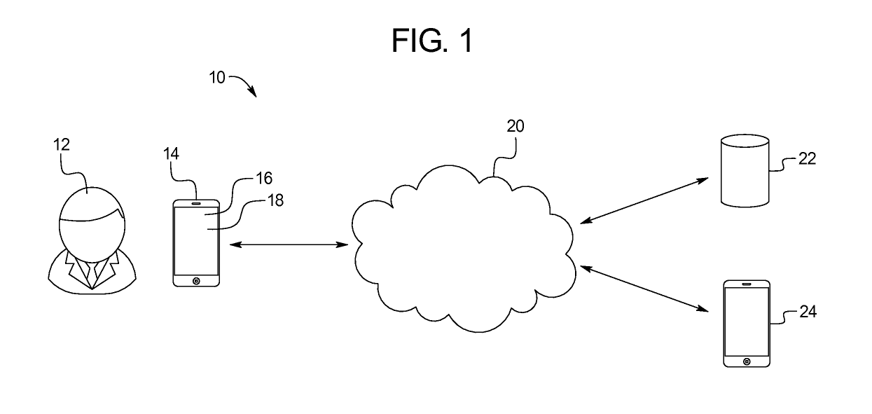

As shown in FIG. 1, the processing engine 16 and memory 18 are embodied in the computing device 14. However, the processing engine 18 and database 20 may, alternatively, be embodied in two or more locations/devices and may be in communication with each other via one or more communications networks 20. For example, the processing engine 16 and memory 18 may be accessible to the computing device 14 through the communications network 20.

The elements shown in FIG. 1 cooperate to enable the user 12 to interact with a computing device 14 that automatically detects and alerts the user 12 of connections between people, places, and things for which data is stored in the memory 18. In further examples, the elements shown in FIG. 1 cooperate to enable the computing device 14 to provide the user 12 with actionable opportunities based on the identified connections. In a simple example, the computing device 14 may identify a connection between two people and an event and automatically provide an opportunity to the user 12 though the computing device 14 to purchase tickets to the event for the connected two people. Of course, any number of variations of connections may be found between people, places, and things using any number of variations of connectors, as described further herein.

The heart of the systems and methods 10 is the processing engine 16 acting on data stored in memory 18. The memory 18 may be any form of data storage mechanism capable of storing the volume of data required for the system 10. The form and structure of the memory 18 is readily known to those skilled in the art and is not limited to a particular form or structure. For just one example, the data may be stored in a database format in a cloud computing system server. However, the data need not be stored in a database format, nor hosted in the cloud. In fact, FIG. 1 shows the memory 18 being resident in the computing device 14.

The processing engine 16 is embodied in a computer processor configured to perform one or more of the steps of the methods described herein. Such processors are readily known to those skilled in the art. In the example shown in FIG. 1, the processing engine 16 is embodied in a smartphone processor configured by software loaded by the execution of a mobile application. As described above, the processing engine 16 may, alternatively, be embodied in a server or other device 24 connected to the computing device 14 through the communications networks 20.

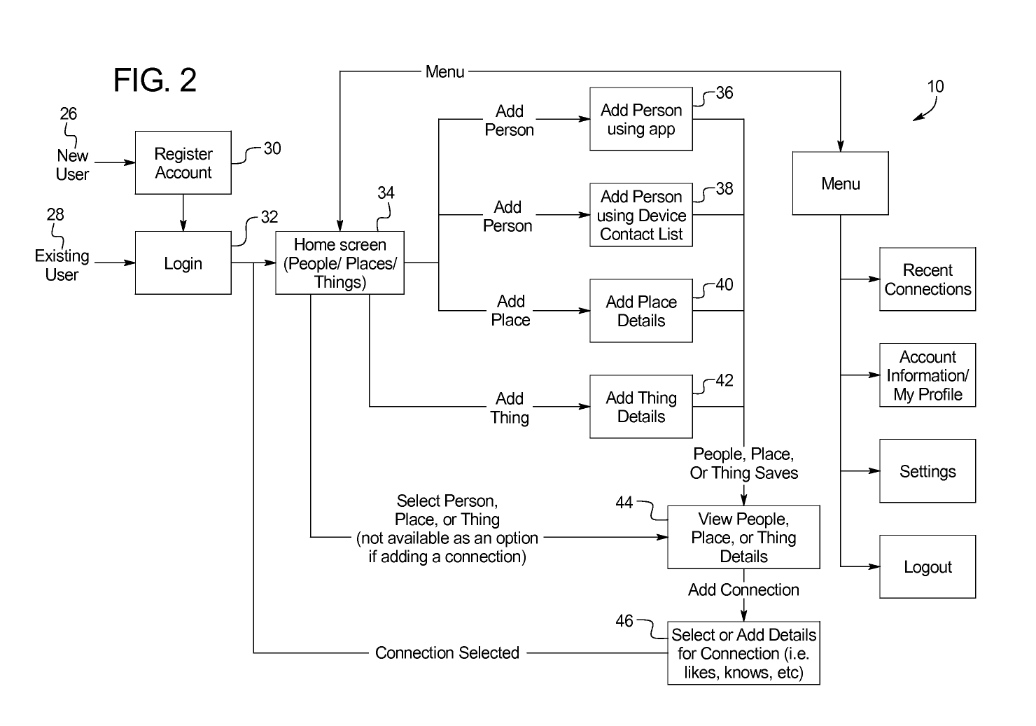

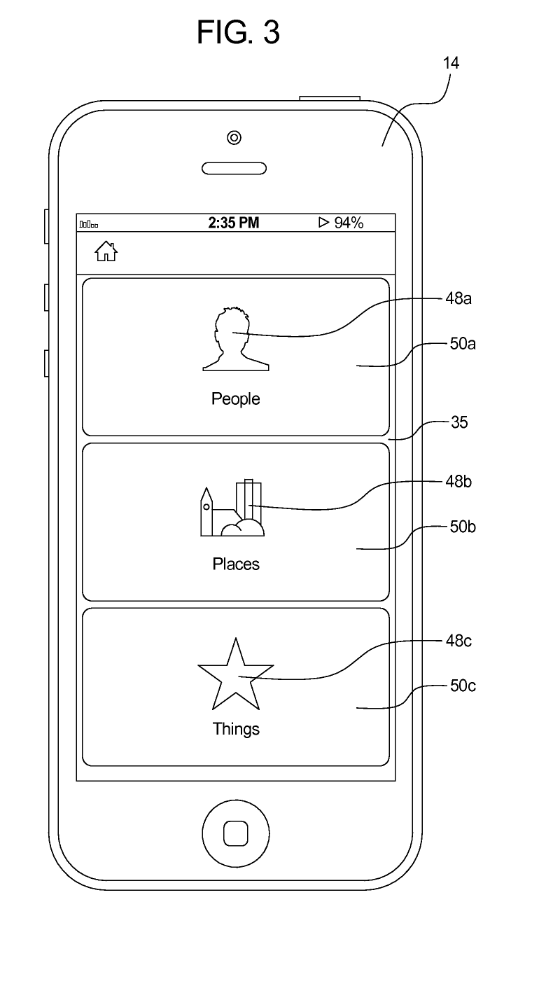

FIG. 2 illustrates, in flow chart form, the steps taken to create and update data used within the systems and methods 10. As shown in FIG. 2, when a new user 26 wants access to the systems and methods 10, the new user 26 must register the account (step 30). Once registered, an existing user 28 must login (step 32) to have access to the home screen (step 34). An example of the home screen 35 is shown in FIG. 3, which is described further below. From the home screen 35, the user may add (or access) people, places, and things. Non-exhaustive examples are provided. It is contemplated that the specific mechanisms shown for adding people, places, and things, are merely representative of various mechanisms that may be used.

As shown, in one example, data regarding a person may be added to the memory 18 by adding the person's information through the application (step 36). In another example, data regarding a person may be added to the memory 18 by adding the person's information using the contact list within the computing device 14 (step 38). It is further contemplated that the information may be pushed or pulled from other systems 22 and other devices 24, such as, associated social media accounts, direct communication with mobile devices, etc.

Similarly, data for places may be added (step 40) and data for things may be added (step 42) through the application or in any other manner understood by the disclosure provided herein.

Once data is added to the system 10, the user 12 may view the data for the people, places, and things (step 44) and additionally select and provide details for connectors (step 46).

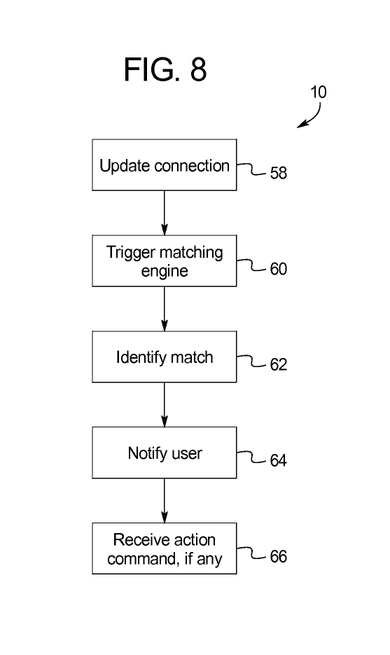

Anytime data is added to the system 10, whether at the category level (i.e., the person, place, and thing level) (steps 36-42) or at the connector level (step 46), the processing engine 16 is triggered to look for synergistic connections in the data. That process is described further with reference to FIG. 8, as will be described further below.

Turning now to FIG. 3. As shown in FIG. 3, the home screen 35 may include user selectable categories through which the user may add data for people, places, and things (steps 36-42) or view data for people, places, or things (step 44). Each category has its own icon (48a-c) and electronic button (50a-c). FIG. 3 is merely one example of a user interface through which the data may be input and viewed. A wide variety of interfaces may be provided that would function well for the systems and methods 10 described herein.

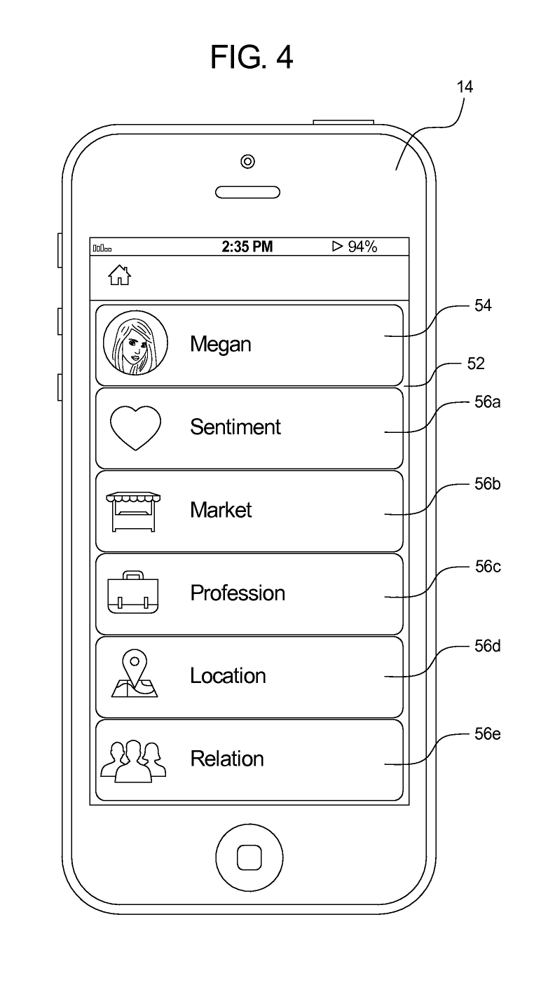

Turning to FIG. 4, a connector screen 52 is shown. The connector screen 52 is essentially a profile screen for a given category (i.e., person, place, or thing). Through the connector screen 52, a user 12 may input or view connector information about a selected category 54 (i.e., a selected person, place, or thing) in any of the five connector types 56: (i) sentiment 56a; (ii) market 56b; (iii) profession 56c; (iv) location 56d; and (v) relation 56e. As described above, “sentiment” may include, for example, likes, dislikes, loves, hates, is allergic to, etc. “Market” may include, for example, buys, sells, owns, uses, has, needs, wants, makes, wears, etc. “Profession” may include, for example, expert at, teaches, works with, etc. “Location” may include, for example, been to, lives in, is from, attended, is part of, takes place in, etc. “Relation” may include, for example, knows, friends with, close friends, acquaintances, married to, siblings with, in-laws, grandparents, etc. These various connections are merely presented for illustrative purposes. It is understood that those skilled in the art will recognize numerous variations or additions to this list based on the descriptions provided herein.

FIG. 4 shows the connector screen 52 for one person. A similar connector screen 52 and similar data exists for each category (i.e., each person, place, and thing) in the system 10. Though it is understood that not every category entry will have data in each connector type. Nor is that level of detail for each category required to accomplish the objectives and advantages of the present subject matter.

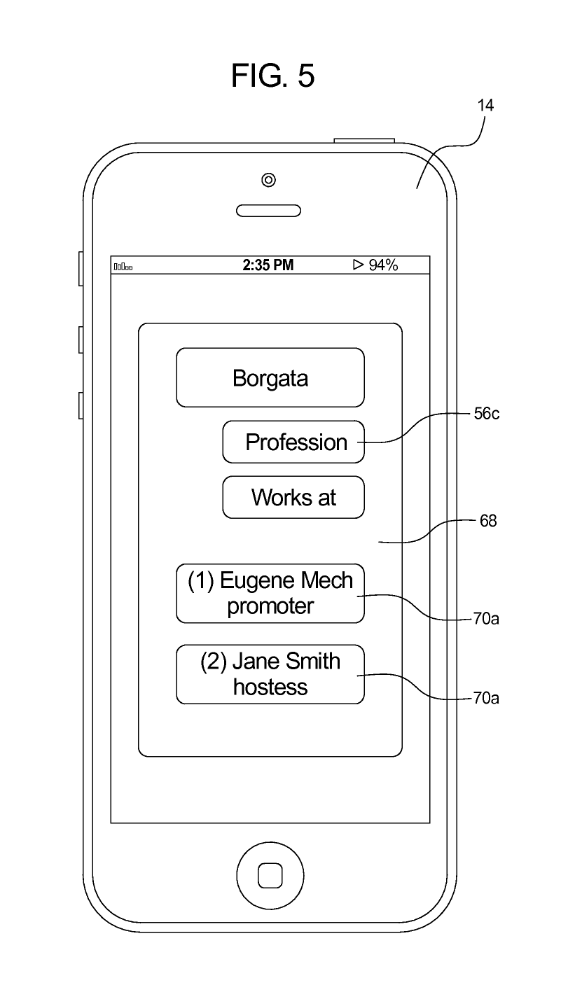

In the example shown in FIG. 5, the user interface displays category and connector information 68 for the “works at” subset of the “profession” connector type 56c data for a selected thing (i.e., Borgata). The data shows two connections; that Eugene Mech works at the Borgata as a promoter 70a; and Jane Smith works at the Borgata as a hostess 70b. FIG. 5 is illustrative of the ease with which data may be organized and accessed in the systems and methods 10 describe herein. Of course, numerous variations in the organization and access to the data may be implemented, whether in hierarchical charts, mind maps, data trees, etc.

Turning now to FIG. 8, anytime new data is entered into the system 10, whether entered directly by the user 12, pushed from a third-party system 22 or device 24, or as a result of naturally evolving data (for example, time-sensitive data that changes over time), the systems and methods 10 described herein perform the following steps: update connector (step 58); trigger matching engine (step 60); identify match (step 62); notify user (step 64); and receive action command, if any (step 66). Each of these steps is described further below.

The update connector step (step 58) is taken each time data within the system 10 is added or updated. As described herein, updates can occur manually through action by the user 12, they may occur automatically as the information is pulled from a third-party data source, they may occur at regularly scheduled times or irregularly. For example, if the system 10 is synched with a social media account, a friend adding a “like” may result in data being pushed to the system as part of the update connector step (step 58). Similarly, a third-party may push a data to systems 10, for example, when the New York Rangers win the Stanley Cup, an authorized retailer may push data that results in the system 10 implementing the update connector step (step 58).

Each additional piece of data within the system is an opportunity to establish a connection, whether a first order connection (direct connection) or a higher order connection (second degree connection, third degree connection, etc.). As a result, every additional piece of information can be a valuable opportunity to trigger the matching engine (step 60). Understanding that a large network of data may require a large amount of processing power, it is contemplated that rather than trigger the matching engine (step 60) every time data is updated, in some embodiments step 60 may only be triggered at predetermined times, in response to a user instruction, etc.

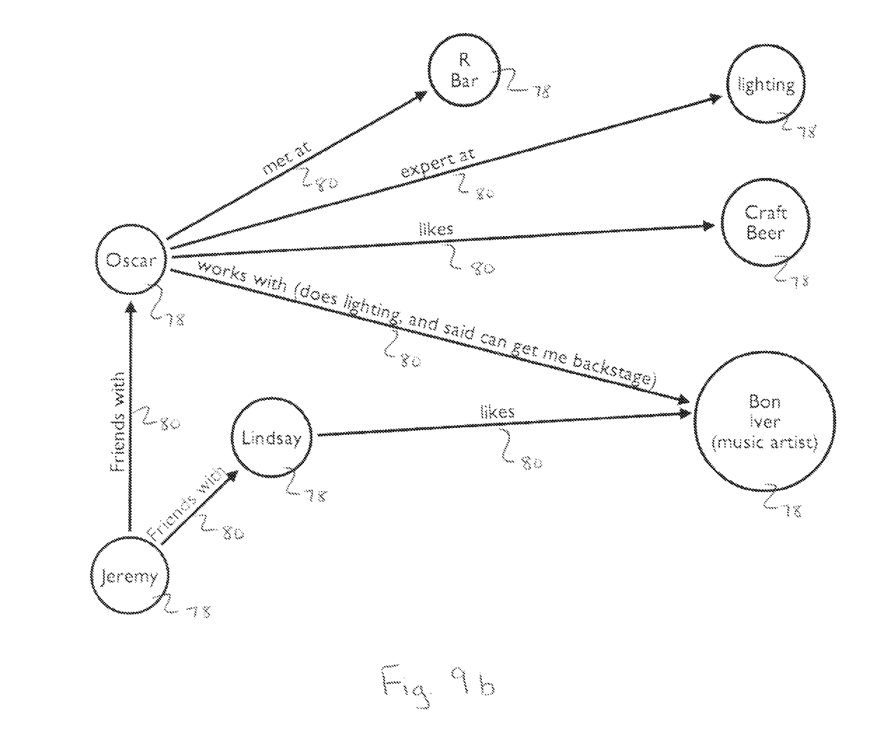

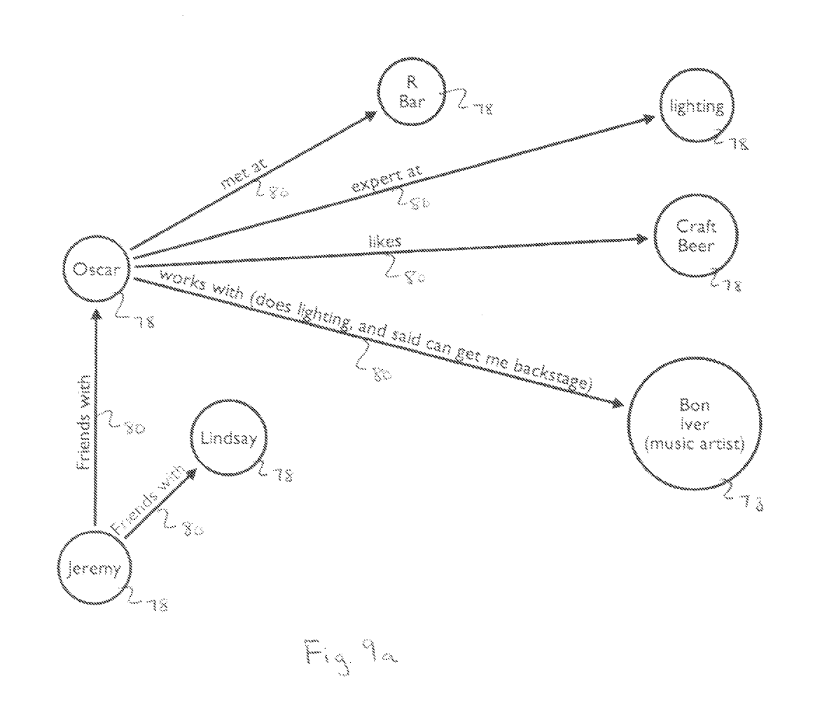

The matching engine is one of the functions performed by the processing engine 16. Its function is described further with respect to FIGS. 9a and 9b and the identify match step (step 62).

The identify match step (step 62) occurs when the matching engine 16 “closes the loop” and establishes a connection between two or more categories (people, places, or things) through a plurality of connectors. A simplified example is provided in FIGS. 9a and 9b.

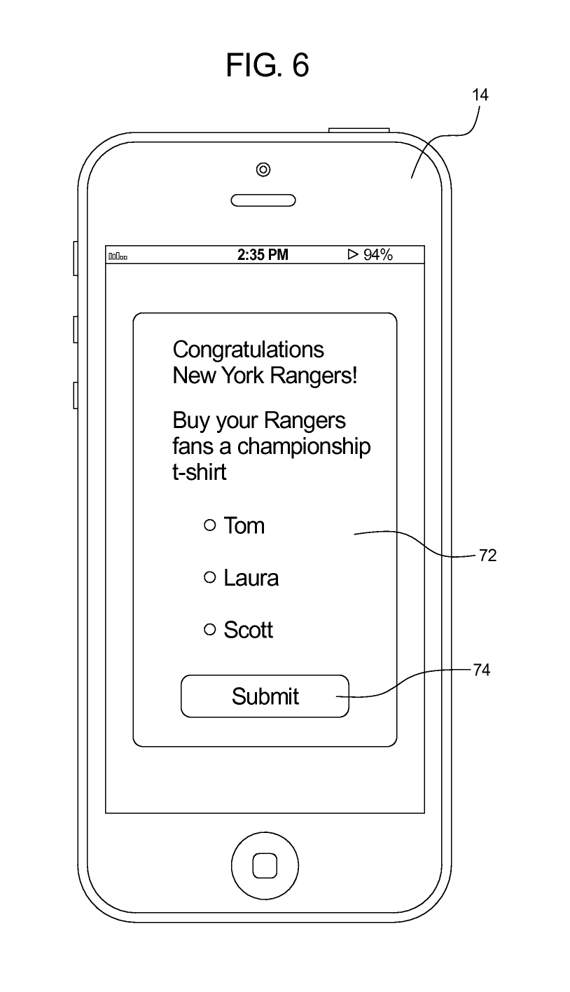

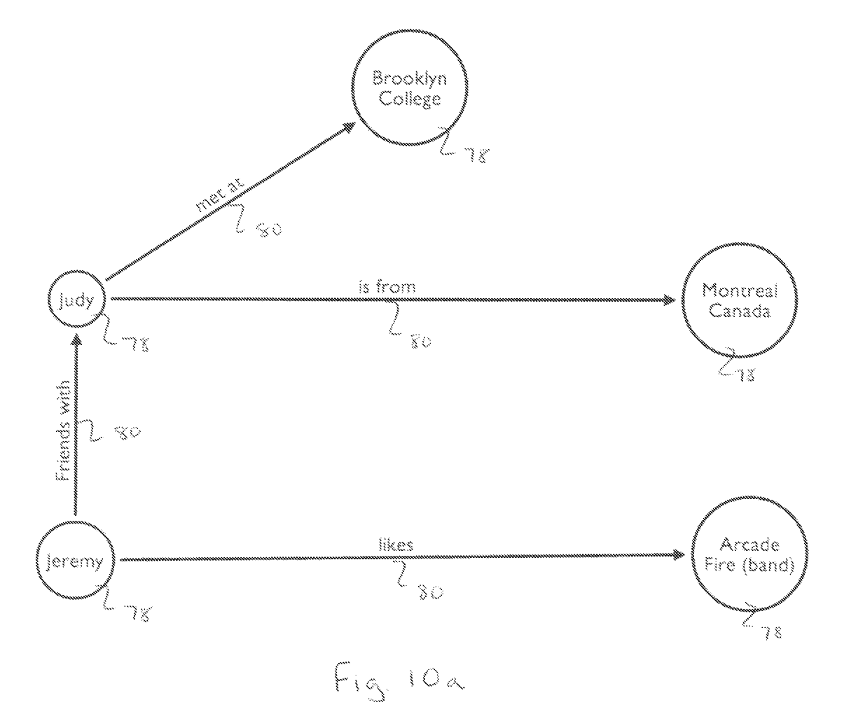

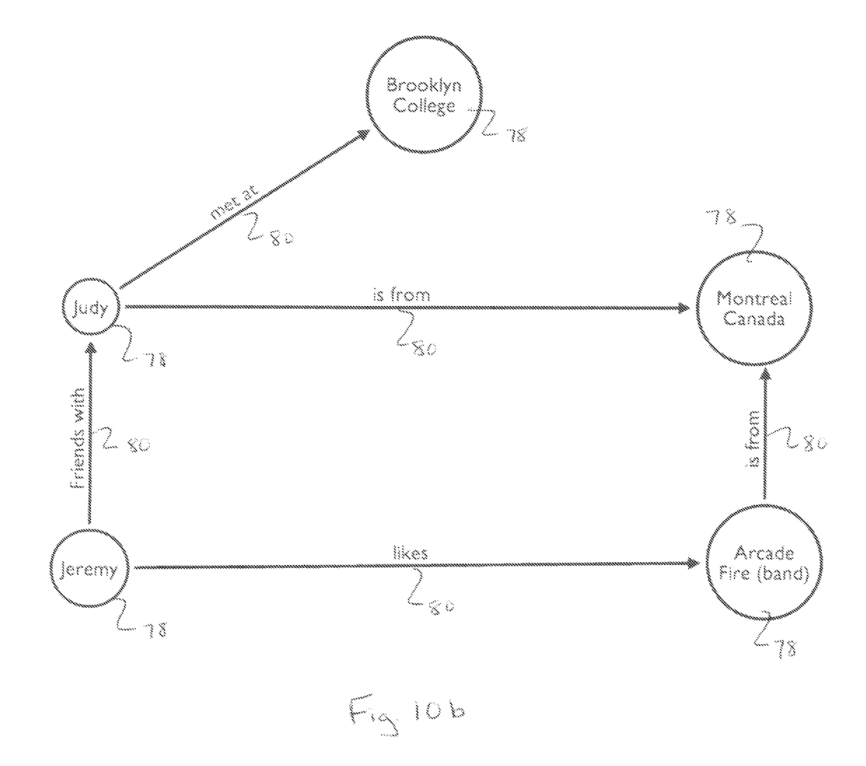

FIG. 9a is a visual representation of a subset of data contained in system 10. As shown in 9a, there are seven categories 78 and six connectors 80. In this example, no series of connectors “close the loop” so there are no matches (i.e., connections) identified. Turning to FIG. 9b, a seventh connector 80 is added (Lindsay likes Bon Iver). As a result of this additional connector 80, there is now a “closed loop” match (i.e., connection) between four categories 78; (1) Jeremy, (2) Oscar, (3) Lindsay, and (4) Bon Iver and four corresponding connectors 80; (1) Jeremy is friends with Lindsay, (2) Jeremy is friends with Oscar, (3) Lindsay likes Bon Iver, and (4) Oscar works with Bon Iver. This closed loop connection indicates a match (i.e., connection) and results in notifying the user (step 64), for example as shown in FIG. 6. FIGS. 10a and 10b are another example of a closed-loop series of categories and connectors that constitute a match. In FIG. 10a, there is no closed-loop. In 10b, the connector 80 between Arcade Fire and Montreal closes the loop to make a match.

As a result of the identification of matching connector data in step 62, as shown in FIG. 9b, the system and method 10 may provide an auto-notification 72 and, optionally, an actionable item 74 within the auto-notification 72. For example, data may be pushed to the system 10 from a third-party database 22. The pushed data may relate to a person, place, or thing, already identified as a category in the system 10, which would, in turn, update the data in the system 10. As shown in FIG. 6, the updated data may have been the New York Rangers winning the Stanley Cup Championship. Updating the “thing” entry New York Rangers with the connector data “won the Stanley Cup Championship in 2014” (step 58) triggers the matching engine (step 60) to identify people that like or love or are fans of the New York Rangers (step 62) and automatically prompts the system 10 to provide the auto-notification 72 shown (step 64). As shown, the auto-notification 72 may include a list of the people identified in step 62 and enable the user 12 to select one or more of the identified people and celebratorily purchase Rangers gear for them as the actionable item 74. FIG. 6 is merely one simplified example of how the method shown in FIG. 8 may be carried out. This example was chosen for its simplicity, though it is well understood that the identification of matches (step 62), the auto-notification 72, and the actionable item 74 may be more complex, and may require matching across or through several degrees of separation.

The auto-notification 72 may appear anytime there is a synergistic match identified by the system 10; a synergistic match being any match in connection data that suggests action by the user, or knowledge of the connection by the user, may be of benefit to him or her. Examples include: the synergistic match between a person's sentiment data (Megan loves wooden bracelets) and another person's market data (Vlad makes and sells wooden bracelets), which may be useful information for gifting; the synergistic matching of a first person's profession and a second person's profession, which may be useful for networking or job searching; and the synergistic matching of a first person's location, a second person's location, and the relationship data for each person, which may be useful in setting up dates or group gatherings (first person is single, second person is single, both people are at Frank's party).

Clearly, not all synergistic matches will be direct matches. In fact, the most valuable matches are likely to be those that are less obvious. For example, a user's data in the system 10 may indicate a band is from Montreal. The data may also indicate one of the women the user would like to date is from Montreal. Although the data does not directly indicate that the woman likes the band, a connection can be drawn and an auto-notification can inform the user than the connection exists.

In response, and as shown, the auto-notification 72 may include an actionable item 74, such as a command to carry out an action. The actionable item 72 may take any of a number of forms, examples of which include: call a person, place, or thing; SMS message a person, place, or thing or a group of persons, places, and things; email a person, place, or thing or a group of persons, places, and things; make a status update through a social media platform; make a purchase; make a sale; etc. This is a non-exhaustive list, but is believed to be adequate to show those skilled in the art a wider scope of actionable items 74 that may be implemented in the system 10.

Actionable items 74 and even the auto-notifications 72 themselves may be adjusted by the user to occur more or less frequently for certain people, places, and things. For example, it may be valuable to see every connection the system 10 identifies related to your significant other, but may be much less important for a distant business contact. The system 10 may provide a user interface through which a user 12 is able to prioritize or otherwise control the threshold importance level required to trigger and auto-notification 72.

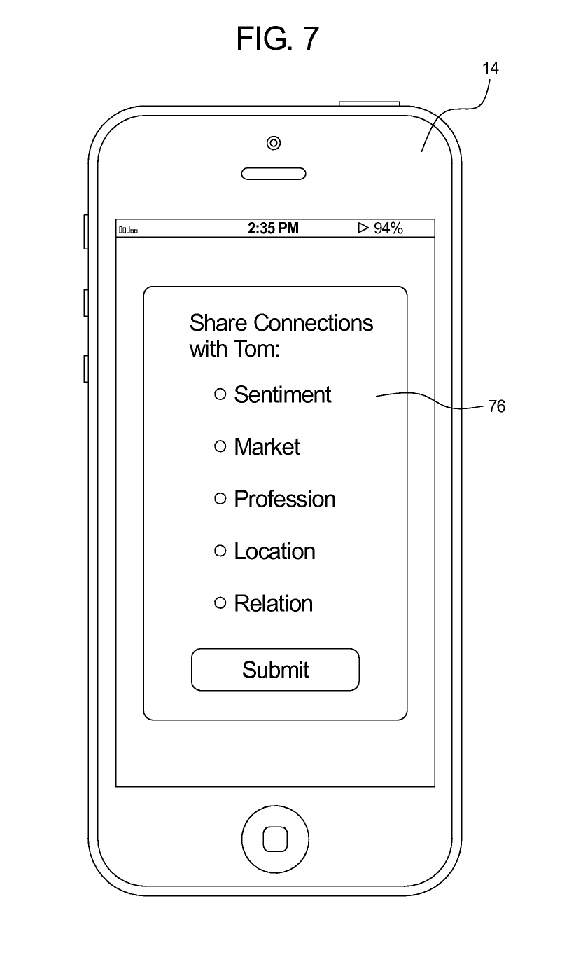

Turning now to FIG. 7, the systems and methods 10 described herein may in some embodiments allow a user 12 to send (i.e., push) to another user selected connection data or allow another user to pull the selected connection data from the user's account. In such embodiments, the user 12 may provide instructions for such controls though a share connection interface 76 like the one shown in FIG. 7. Using the controls provided in the connection interface 76 shown in FIG. 7, the user 12 controls the extent to which connection information is shared with a third-party, in this case Tom. By selecting which type of data is shared, the user 12 may maintain control of the connection data at any level of specificity, whether by categories, connector type, or at a more granular level of detail. Variations of the controls shown in the connection interface 76 will be understood by those skilled in the art based on the descriptions provided herein.

It should be noted that various changes and modifications to the embodiments described herein will be apparent to those skilled in the art. Such changes and modifications may be made without departing from the spirit and scope of the present invention and without diminishing its attendant advantages. For example, various embodiments of the method may be provided based on various combinations of the features and functions from the subject matter provided herein.

We claim:

1. A computer implemented system comprising:
a processing engine embodied in a processor that is in operable communication with a user interface, wherein the processor receives data elements including a plurality of categories and a plurality of connectors, wherein each category represents a person, a place, or a thing, and each connector represents a connection between two categories, wherein the processing engine acts on the categories and connectors received to determine a closed-loop series of categories and connectors and, in response to the determination of a closed-loop series of categories and connectors, the processing engine automatically generates a notification of the closed-loop through the user interface.

2. The system of claim 1 wherein the notification is an email.

3. The system of claim 1 wherein the notification is an SMS message.

4. The system of claim 1 wherein the notification is a pop up notification from a mobile application.

5. The system of claim 1 wherein the notification through the user interface includes an actionable item.

6. The system of claim 5 wherein the actionable item includes an option to purchase goods or services.

7. The system of claim 5 wherein the actionable item includes an option to communicate the notification to third parties.

8. The system of claim 5 wherein the actionable item is includes an option to publish the notification through social media.

9. A computer implemented method comprising the steps of:
updating data elements in memory associated with a processor embodying a matching engine, wherein the data elements include a plurality of categories and a plurality of connectors, wherein each category represents a person, a place, or a thing, and each connector represents a connection between two categories;
triggering the matching engine to act on the categories and connectors to determine a closed-loop series of categories and connectors to identify a match; and
notifying a user of the match with a notification.

10. The method of claim 9 further including the step of receiving an action command from the user in response to the notification.

11. The method of claim 9 wherein the notification is an email.

12. The system of claim 9 wherein the notification is an SMS message.

13. The system of claim 9 wherein the notification is a pop up notification from a mobile application.

14. The system of claim 9 wherein the notification includes an actionable item.

15. The system of claim 14 wherein the actionable item includes an option to purchase goods or services.

16. The system of claim 14 wherein the actionable item includes an option to communicate the notification to third parties.

17. The system of claim 14 wherein the actionable item is includes an option to publish the notification through social media.
